(19) United States
(12) Patent Application Publication
(10) Pub. No.: US 2019/0215881 A1
(43) Pub. Date: Jul. 11, 2019

(54) METHOD FOR INCREASING POSSIBILITY OF A SUCCESSFUL CALL-SETUP AND A COMMUNICATIONS APPARATUS UTILIZING THE SAME

(71) Applicant: MEDIATEK INC., Hsin-Chu (TW)

(72) Inventors: Kai-Yuan HOU, Douliu City (TW); Chi-Ju CHANG, Taipei City (TW)

(21) Appl. No.: 15/865,514

(22) Filed: Jan. 9, 2018

(51) Int. Cl. H04W 76/12; H04W 76/23; H04W 8/06; H04W 76/18; H04L 29/08

(52) U.S. Cl. CPC H04W 76/12; H04W 76/23; H04L 67/327; H04W 76/18; H04W 8/06

(57) ABSTRACT

A communications apparatus includes a radio transceiver and a processor. The radio transceiver transmits or receives wireless radio frequency signals to or from an air interface. The processor determines whether one of a plurality of predetermined call-setup behaviors has occurred. If one of the plurality of predetermined call-setup behaviors has occurred, the processor performs a network access enhancement procedure to increase the possibility of a successful call-setup.

### BACKGROUND OF THE INVENTION

### Field of he Invention

The invention relates to methods for avoiding call failure in a communications apparatus, especially for avoiding successive call failures in a communications apparatus.

### Description of the Related Art

The term “wireless” normally refers to an electrical or electronic operation, which is accomplished without the use of a “hard wired” connection. “Wireless communications” is the transfer of information over a distance without the use of electrical conductors or wires. The distances involved may he short (a few meters for television remote controls) or very long (thousands or even millions of kilometers for radio communications). The best known example of wireless communications is the cellular telephone. Cellular telephones use radio waves to enable an operator to make phone calls to another party from many locations worldwide. They can he used anywhere, as long as there is a cellular telephone site to house equipment that can transmit and receive signals, which are processed to transfer both voice and data to and from the cellular telephones.

There are various well-developed and well-defined cellular communications technologies. For example, the Global System for Mobile communications (GSM) is a well-defined and commonly used communications system, which uses time division multiple access (TDMA) technology, which is a multiplex access scheme for digital radio, to send voice, data, and signaling data (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. Wireless Fidelity (Wi-Fi) is a technology defined by the 802.11 engineering standard that can be used for home networks, mobile phones, and video games to provide a high-frequency wireless local area network. Long-Term Evolution (LTE) is a standard for wireless communication of high-speed data for mobile phones and data terminals. It is based on the GSM/EDGE and UMTS/HSPA network technologies, increasing the capacity and speed using a different radio interface together with core network improvements.

In order to provide more efficient communications services and improve user experience, methods for avoiding successive call failure in a communications apparatus are provided.

### BRIEF SUMMARY OF THE INVENTION

Communications apparatuses and methods for increasing the possibility of a successful call-setup of a communications apparatus are provided. An exemplary embodiment of a communications apparatus comprises a radio transceiver and a processor. The radio transceiver transmits or receives wireless radio frequency signals to or from an air interface. The processor determines whether one of a plurality of predetermined call-setup behaviors has occurred. If one of the plurality of predetermined call-setup behaviors has occurred, the processor performs a network access enhancement procedure to increase the possibility of a successful call-setup.

An exemplary embodiment of a method for increasing the possibility of a successful call-setup of a communications apparatus comprises: determining whether one of a plurality of predetermined call-setup behaviors has occurred; and if one of the plurality of predetermined call-setup behaviors has occurred, performing a network access enhancement procedure.

An exemplary embodiment of a method for increasing the possibility of a successful call-setup of a communications apparatus registered at a first network comprises: determining whether a call-setup attempt failure or a call failure has occurred; and if a call-setup attempt failure or a call failure has occurred, increasing transmission power of the communications apparatus for transmitting wireless radio frequency signals, or selecting a second network which is different from the first network and which is also not in a failed network list and performing a registration procedure to register at the network, or performing a re-registration procedure to register at the first network, or performing a reboot procedure for rebooting a modem or a radio transceiver of the communications apparatus.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary block diagram of a communications apparatus according to an embodiment of the invention;

FIG. 2 shows an exemplary block diagram of a modem according to an embodiment of the invention;

FIG. 3 is a flow chart of a method for increasing the possibility of a successful call-setup of a communications apparatus according to an embodiment of the invention;

FIG. 4 is an exemplary diagram showing a message flow when performing the location registration in a network in CS domain;

FIG. 5 is an exemplary diagram showing a message flow when performing the location registration in a network in a PS domain;

FIG. 6 an exemplary diagram showing a message flow when performing a re-registration procedure according to an embodiment of the invention;

FIG. 7A is a flow chart of a method for increasing the possibility of a successful call-setup of a communications apparatus according to a first embodiment of the invention;

FIG. 7B is a flow chart of a method for increasing the possibility of a successful call-setup of a communications apparatus according to a second embodiment of the invention;

FIG. 7C is a flow chart of a method for increasing the possibility of a successful call-setup of a communications apparatus according to a third embodiment of the invention;

FIG. 7D is a flow chart of a method for increasing the possibility of a successful call-setup of a communications apparatus according to a fourth embodiment of the invention: and

FIG. 8 is a flow chart of a method for increasing the possibility of a successful call-setup of a communications apparatus according to a fifth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

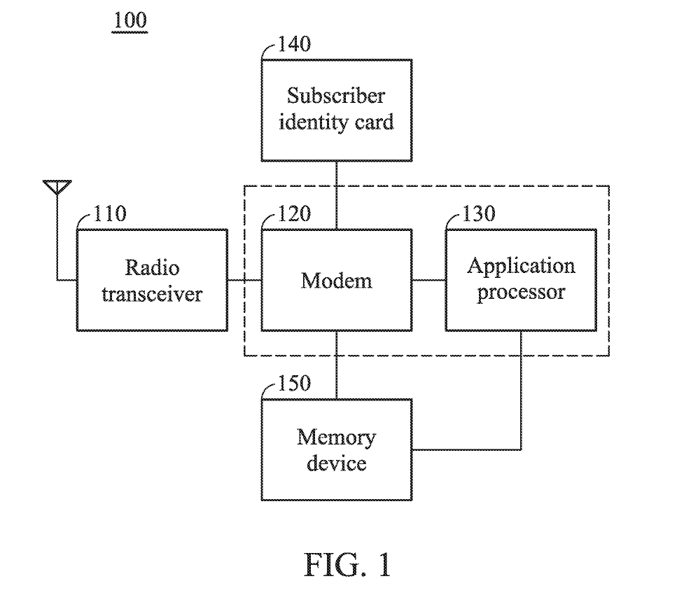

FIG. 1 shows an exemplary block diagram of a communications apparatus according to an embodiment of the invention. The communications apparatus 100 may be a portable electronic device, such as a Mobile Station (MS, which may be interchangeably referred to as User Equipment (UE)). The communications apparatus 100 may comprise at least an antenna module comprising at least one antenna, a radio transceiver 110, a modem 120, an application processor 130, a subscriber identity card 140, and a memory device 150. The radio transceiver 110 may receive wireless radio frequency signals from an air interface via the antenna module, transmit wireless radio frequency signals to the air interface via the antenna module and perform RF signal processing. For example, the radio transceiver 110 may convert the received signals into intermediate frequency (IF) or baseband signals to be processed, or receive the IF or baseband signals from the modern 120 and convert the received signals into wireless radio frequency signals to be transmitted to a network device. According to an embodiment of the invention, the network device may be a cell, an evolved node B, a base station, a Mobility Management Entity (MME) etc., at the network side and communicating with the communications apparatus 100 via the wireless radio frequency signals.

The radio transceiver 110 may comprise a plurality of hardware devices to perform radio frequency conversion and RF signal processing. For example, the radio transceiver 110 may comprise a power amplifier for amplifying the RF signals, a filter for filtering unwanted portions of the RF signals and/or a mixer for performing radio frequency conversion. According to an embodiment of the invention, the radio frequency may be, for example, 900 MHz or 1800 MHz for a Global System for Mobile communication (GSM), or 1900 MHz for a Universal Mobile Telecommunications System (UMTS), or the frequency of any specific frequency band for a Long-Term Evolution (LTE) system, etc.

The modem 120 may be a cellular communications modem configured for handling cellular system communications protocol operations and processing the IF or baseband signals received from or to be transmitted to the radio transceiver 110. The application processor 130 is configured for running the operating system of the communications apparatus 100 and running application programs installed in the communications apparatus 100. In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an International Mobile Subscriber Identity (IMSI) and a set of SIM application toolkit (SAT) commands and may provide storage space for phone book contacts. The memory device 150 may be coupled to the modem 120 and application processor 130 and may store system data or user data.

It should be noted that, in order to clarify the concept of the invention, FIG. 1 presents a simplified block diagram in which only the elements relevant to the invention are shown. For example, in some embodiments of the invention, the communications apparatus may further comprise some peripheral devices not shown in FIG. 1. In another example, in some embodiments of the invention, the communications apparatus may further comprise a central controller coupled to the modem 120 and the application processor 130. Therefore, the invention should not be limited to what is shown in FIG. 1.

It should be noted that, although FIG. 1 shows a single-card single-standby application, the invention should not be limited thereto. For example, in some embodiments of the invention, the communications apparatus may comprise multiple subscriber identity cards to support multiple radio access technologies (RATs) communications. In the multiple RATs communications applications, the modem, the radio transceiver and/or the antenna module may be shared by the subscriber identity cards and may have the capability of handling the operations of multiple cellular system communications protocols and processing the corresponding RF, IF or baseband signals in compliance with multiple cellular system communications protocols. Those who are skilled in this technology can still make various alterations and modifications based on the descriptions given above to derive the communications apparatuses comprising multiple radio transceivers and/or multiple antenna modules for supporting multiple RAT wireless communications without departing from the scope and spirit of this invention. Therefore, in some embodiments of the invention, the communications apparatus may be designed to support a multi-card multi-standby application by making some alterations and modifications.

It should be noted that the subscriber identity card 140 may be dedicated hardware cards as described above, or in some embodiments of the invention, there may be individual identifiers, numbers, addresses, or the like which are burned in the internal memory device of the corresponding modern and are capable of identifying the communications apparatus. Therefore, the invention should not be limited to what is shown in the figures.

It should be noted that in some embodiments of the invention, the communications apparatus may further support multiple INISIs.

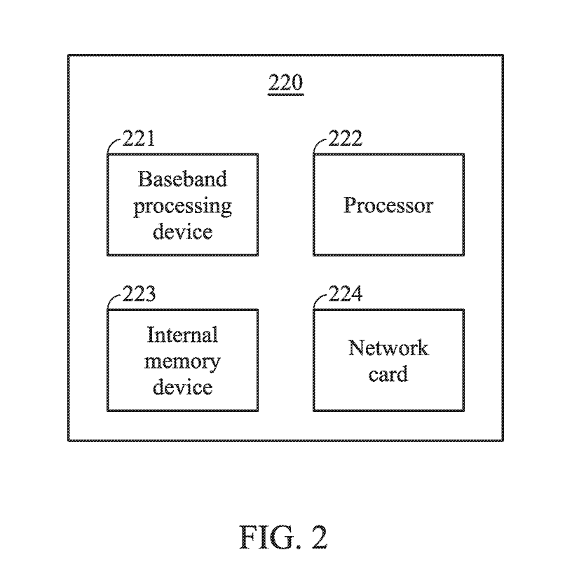

FIG. 2 shows an exemplary block diagram of a modern according to an embodiment of the invention. The modem 220 may be the modem 120 shown in FIG. 1 and may comprise at least a baseband processing device 221, a processor 222, an internal memory device 223 and a network card 224. The baseband processing device 221 may receive the IF or baseband signals from the radio transceiver 110 and perform IF or baseband signal processing. For example, the baseband processing device 221 may convert the IF or baseband signals into a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, a encoder for signal encoding, a decoder for signal decoding, and so on.

The processor 222 may control the operations of the modem 220. According to an embodiment of the invention, the processor 222 may be arranged to execute the program codes of the corresponding software module of the modem 220. The processor 222 may maintain and execute the individual tasks, threads, arid/or protocol stacks for different software modules. In a preferred embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may also read data from the subscriber identity card coupled to the modem, such as the subscriber identity card 140, and write data to the subscriber identity card. The internal memory device 223 may store system data and user data for the modern 220. The processor 222 may also access the internal memory device 223.

The network card 224 provides Internet access services for the communications apparatus. It should be noted that, although the network card 224 shown in FIG. 2 is configured inside of the modem, the invention should not be limited thereto. In some embodiments of the invention, the communications apparatus may also comprise a network card configured outside of the modem, or the communications apparatus may also be coupled to an external network card for providing Internet access services. Therefore, the invention should not be limited to any specific implementation method.

It should be noted that, in order to clarify the concept of the invention, FIG. 2 presents simplified block diagrams in which only the elements relevant to the invention are shown. Therefore, the invention should not be limited to what is shown in FIG. 2.

It should be noted that in some embodiments of the invention, the modem may comprise more than one processor and/or more than one baseband processing device. For example, the modem may comprise multiple processors and or multiple baseband processing devices for supporting multi-RAT operations. Therefore, the invention should not be limited to what is shown in FIG. 2.

It should be noted that in some embodiments of the invention, the baseband processing device 221 and the processor 222 may be integrated into one processing unit, and the modem may comprise one or more multiple such processing units, for supporting multi-RAT operations. Therefore, the invention should not be limited to what is shown in FIG. 2.

In the existing design, the communication apparatus searches for a suitable network to camp on and register at based on a stored frequency list. As an example, the records in the stored frequency list are ranked according to their signal strength. The communication apparatus usually tries to camp on a cell, an evolved node B or a base station (hereinafter called the network device) corresponding to a frequency with the highest signal strength first.

Another approach is to build up a most recently used (MRU) list that records information regarding the frequency of the most recently used (that is, camped on or registered at) network devices. If searching network is required, the communication apparatus usually tries to camp on and register at the network device that was most recently used in the MRU list first.

If the communications apparatus is currently unable to use the service (for example, to set up a call) provided by the network device that the communications apparatus currently camped on or registered at, the communications apparatus may determine to select another network device to camp on or register at. However, if the communications apparatus still selects the target network based on the stored frequency list or the MRU, successive call failures may occur since the same network device will be selected. To solve this problem, methods for avoiding call failure, especially successive call failures, and increasing the possibility of a successful call-setup of the communications apparatus are provided.

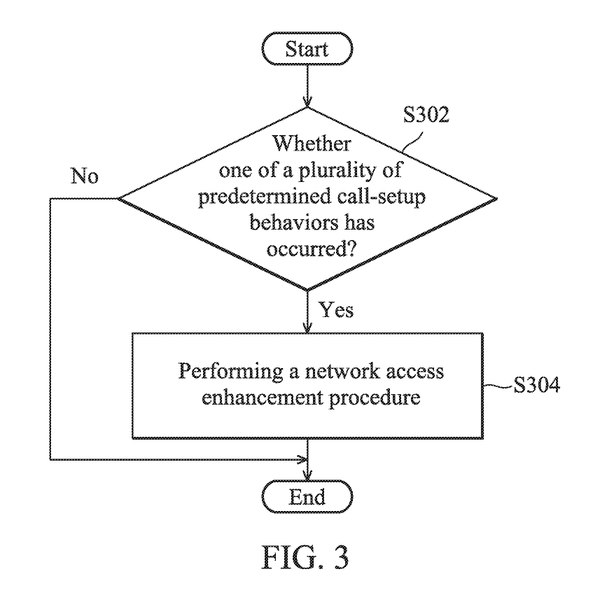

FIG. 3 is a flow chart of a method for increasing the possibility of a successful call-setup of a communications apparatus (e.g. the communications apparatus 100) according to an embodiment of the invention. First of all, the processor (e.g. the processor 222, or the processing unit as discussed above) determines whether one of a plurality of predetermined call-setup behaviors has occurred (Step S302). If one of the plurality of predetermined call-setup behaviors has occurred, the processor performs a network access enhancement procedure (Step S304).

According to an embodiment of the invention, the plurality of predetermined call-setup behaviors may comprise one or a combination of: successive call-setup attempt failures, successive call failures, a call-setup attempt made in a poor signal quality area, a reboot procedure that has been triggered, or a flight-mode leaving procedure that has been triggered,

The predetermined call-setup behaviors may be performed by the user of the communications apparatus, and may be detected by the processor 222 of the modem 120 or by the application processor 130, if the application processor 130 detects that at least one or a combination of the predetermined call-setup behaviors has occurred, the application processor 130 may inform the processor 222 of the predetermined call-setup behavior, and the processor 222 may perform the network access enhancement procedure.

According to a first embodiment in a first aspect of the invention, If the processor 222 or the application processor 130 determines that more than one failure of a call-setup attempt or more than one call failure has occurred within a predetermined period of time, the processor 222 or the application processor 130 determines that successive call-setup attempt failures or successive call failures have occurred. It should be noted that the call-setup attempts may be made to the same or different destination numbers, and the invention should not be limited thereto. It should be noted that the call-setup attempt may refer to the behavior when the user attempts to dial a number or to set up a call, and the call failure may refer to the failure before or during the call. That is, the call failure may be a situation when the call is unable to be successfully established or the call is successfully established but dropped (which may be or may be not intentionally dropped by the user).

According to a second embodiment of the first aspect of the invention, instead of detecting call failure, the processor 222 or the application processor 130 may also detect the time span between two successive call-setup attempts. If the time span between two successive call-setup attempts is shorter than a predetermined threshold, the processor 222 may also determine to perform a network access enhancement procedure. It should be noted that the call-setup attempts may be made to the same or a different destination number, and the invention should not be limited thereto.

According to a third embodiment of the first aspect of the invention, if the processor 222 or the application processor 130 determines that a call-setup attempt was made in a weak signal area, the processor 222 may determine to perform a network access enhancement procedure. In the embodiments of the invention, the weak signal area may be an out-of-service area, an area with poor signal strength (e.g. lower than a predetermined threshold for a communication to be stably or successfully established), poor signal quality (e.g. the signal to noise ratio is lower than a predetermined threshold), or an area in which a call failure or call-setup failure has occurred.

According to a fourth embodiment of the first aspect of instead of detecting the geographic area, the processor 222 or the application processor 130 may also detect the operation state of the communications apparatus 100. If the processor 222 or the application processor 130 determines that a call-setup attempt is made when the communications apparatus operates in an out-of-service or a limited service state, the processor 222 may determine to perform a network access enhancement procedure.

According to a fifth embodiment of the first aspect of the invention, the predetermined call-setup behavior may also have a predetermined behavior pattern. In an embodiment of the invention, the predetermined behavior pattern may be call failure->reboot of the communications apparatus->another call-setup attempt.

In the embodiments of the invention, if the processor 222 or the application processor 130 detects that a reboot procedure has been triggered after a call-setup attempt failure has occurred, a call-setup attempt has occurred after a reboot procedure has been triggered, or a combination thereof, the processor 222 may determine that the predetermined call-setup behavior has occurred. The reboot procedure may be triggered by the user to reboot (that is, power off and then power on) the communications apparatus 100.

According to a sixth embodiment of the first aspect of the invention, the predetermined behavior pattern may be call failure->flight-mode reentry->another call-setup attempt.

In the embodiments of the invention, if the processor 222 or the application processor 130 detects that a flight-mode leaving procedure has been triggered after a call-setup attempt failure has occurred, a call-setup attempt has occurred after a flight-mode leaving procedure has been triggered, or a combination thereof, the processor 222 may determine the predetermined call-setup behavior has occurred. The flight-mode leaving procedure may be triggered by the user to enter flight mode and then leave flight mode.

If one of the plurality of predetermined call-setup behaviors illustrated above has occurred, the processor 222 may determine to perform a network access enhancement procedure as will be illustrated in the following paragraphs.

According to a first embodiment in a second aspect of the invention, in the network access enhancement procedure, the processor 222 may increase transmission power for transmitting the wireless radio frequency signals. The processor 222 may instruct the power amplifier to increase the gain for amplifying the RF signals, or the processor 222 may issue a corresponding command to instruct any other hardware device to increase the transmission power for transmitting the wireless radio frequency signals.

It should be noted that the communications apparatus usually negotiates the transmission power with the network device and has to obey the negotiation result. However, in the embodiment of the invention, the processor 222 may not obey the negotiation result and increase the transmission power if determining that one of the plurality of predetermined call-setup behaviors illustrated above has occurred, so as to increase the possibility of a successful call-setup.

According to a second embodiment of the second aspect of the invention, a failed network list may be stored in the memory device 150 or the internal memory device 223. The failed network list records information regarding networks in which call-setup attempt failures or call failures have occurred. In the network access enhancement procedure, the processor 222 may select a predetermined network which is not in the failed network list to perform a registration procedure.

To be more specific, according to an embodiment of the invention, the processor 222 may build up a failed network list based on one or more previous call set-up attempt results. The failed network list may comprise information regarding the network in which a call-setup attempt failure or a call failure has occurred. Here, the network refers to the network in which a network device provides wireless communications services.

The information regarding the network may comprise the cell ID, the cell frequency, the frequency band, the tracking area (TA) the PLMN, and/or the radio access technology (RAT) of the associated network device. In addition, the failed network list may also record the number of call-setup attempt failures or call failures that have occurred when the communications apparatus camped on and/or registered at the network device.

If the processor 222 determines that one of the plurality of predetermined call-setup behaviors illustrated above has occurred and determines to trigger a registration procedure, the processor 222 may select a predetermined network device which is not in the failed network list and perform a registration procedure to register at the network device.

According to another embodiment of the invention, the processor 222 may also rank the network devices recorded in the failed network list according to the number of call-setup attempt failures or call failures, and select the one with the least number of failures.

In addition, the processor 222 may also update the failed network list according to one or more call set-up attempt results recently obtained, or may delete the record regarding the predetermined network device after determining that a call can be successfully set up in the service network provided by the predetermined network device.

On the other hand, according to another embodiment of the invention, the processor 222 may also receive information regarding a failed network list from a network device or a peer communications apparatus. The network device may be the one that the communications apparatus 100 currently camped on or registered at, and the peer communications apparatus may be another communications apparatus in the network. The records in the failed network list may be obtained based on the network access experience of any other communications apparatus.

The information regarding the network may comprise the cell ID, the cell frequency, the frequency band, the tracking area (TA) the PLMN, and/or the radio access technology (RAT) of the associated network device. In addition, the failed network list may also record the number of call-setup attempt failures or call failures that have occurred when any communications apparatus was camped on and/or registered at the network device.

The processor 222 may select a predetermined network which is not in the failed network list to perform a registration procedure, or rank the network devices recorded in the failed network list according to the number of call-setup attempt failures or call failures, and select the one with the least number of failures.

In addition, the processor 222 may also update the failed network list according to the updated information received from a network device or a peer communications apparatus, or may delete the record regarding the predetermined network device after determining that a call can be successfully set up in the service network provided by the predetermined network device.

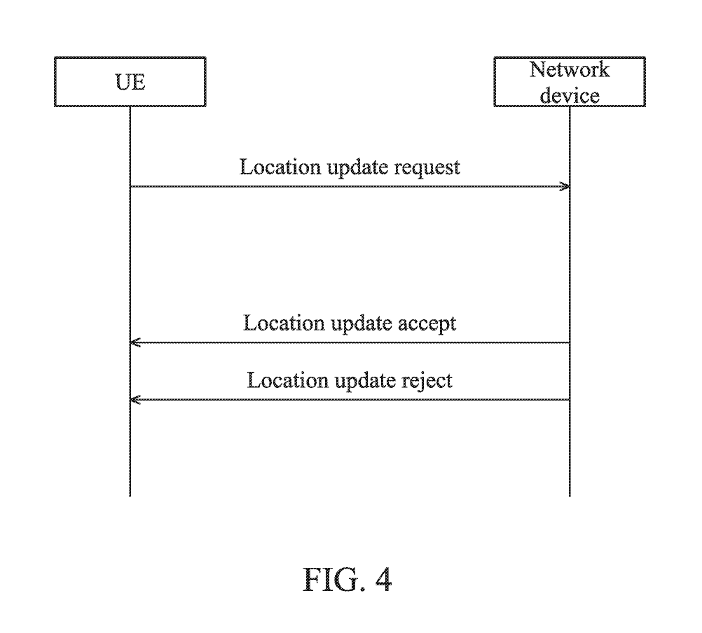

FIG. 4 is an exemplary diagram showing a message flow Mien performing the location registration in a network in circuit switch (CS) domain. The UE may send a location update request to the network device. Upon receiving the location update request, the network device may accept the request and send a location update accept to the UE or reject the request and send a location update reject to the UE.

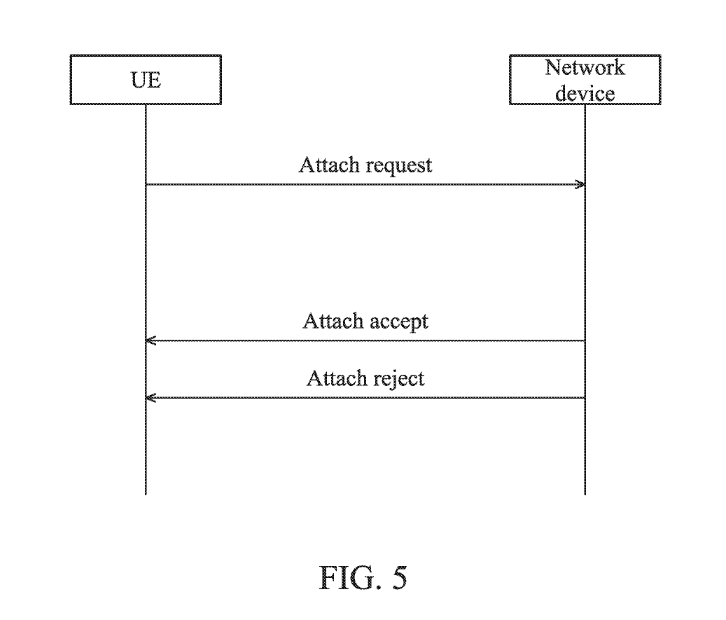

FIG. 5 is an exemplary diagram showing a message flow when performing the location registration in a network in packet switch (PS) domain. The UE may send an attach request to the network device. Upon receiving the attach request, the network device may accept the request and send an attach accept to the UE or reject the request and send an attach reject to the UE.

According to a third embodiment of the second aspect of the invention, in the network access enhancement procedure, the processor may perform a re-registration procedure. To be more specific, suppose that the communications apparatus 100 currently registered at a first network provided by a first network device (that is, after the location update accept as shown in FIG. 4 and/or the attach accept as shown in FIG. 5 has been successfully received). If one of the plurality of predetermined call-setup behaviors illustrated above has occurred, the processor 222 may determine to perform a re-registration procedure.

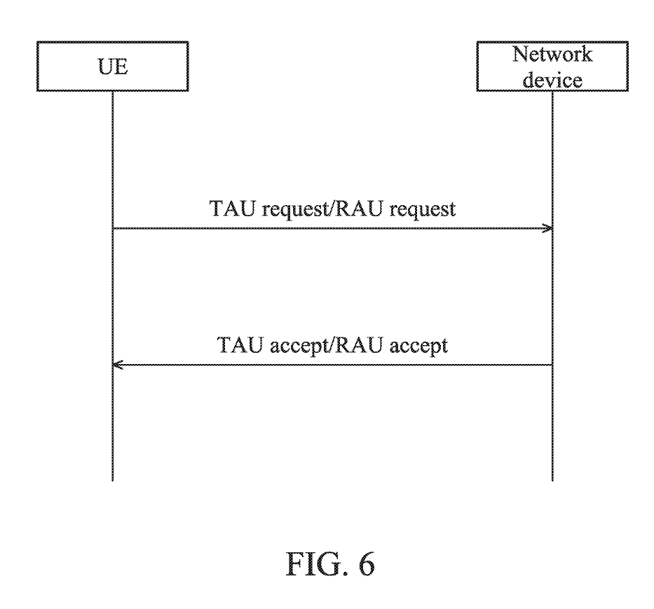

FIG. 6 an exemplary diagram showing a message flow when performing a re-registration procedure according to an embodiment of the invention. In a re-registration procedure, the communications apparatus 100 may transmit the location update request as shown in FIG. 5 to the same first network device, or may transmit the Tracking Area Update (TAU)/Routing Area Update(RAU) request to the same first network device as shown in FIG. 6.

According to a fourth embodiment of the second aspect of the invention, in the network access enhancement procedure, the processor may perform a reboot procedure. According to an embodiment of the invention, in the reboot procedure, the processor 222 may set up the corresponding register values, so that the modem 120 can be powered down and then powered on to complete the reboot procedure. According to an embodiment of the invention, in the reboot procedure, the processor 222 may also set up the corresponding register values, such that one or more hardware devices in the radio transceiver 110 can be powered down and then powered on to complete the reboot procedure.

It should be noted that the reboot procedure may also be triggered by the application processor 130, or the register values may be set up by the application processor 130, and the invention should not be limited thereto. It should be noted that before powering down the modem 120 or the radio transceiver 110, the processor 222 may transmit a detach request to the first network device to detach from the first network, and then transmit an attach request as shown in FIG. 5 to the first network after it powers on.

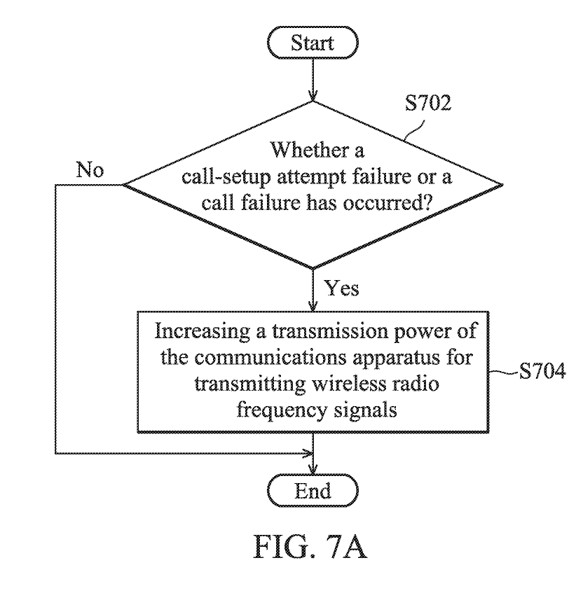

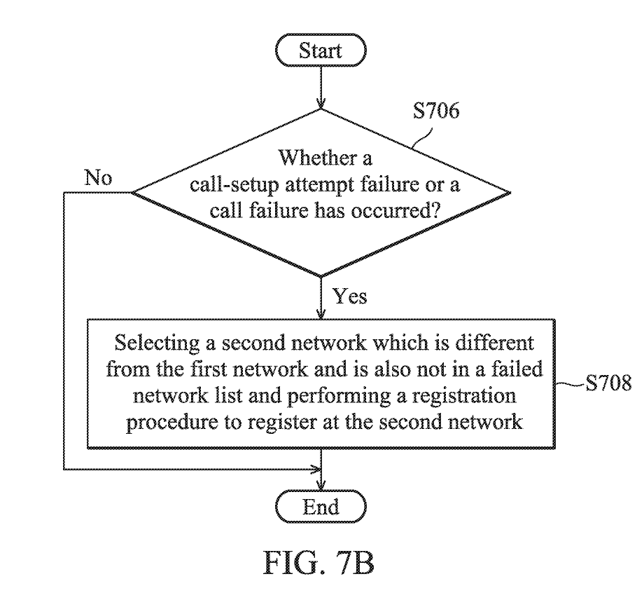

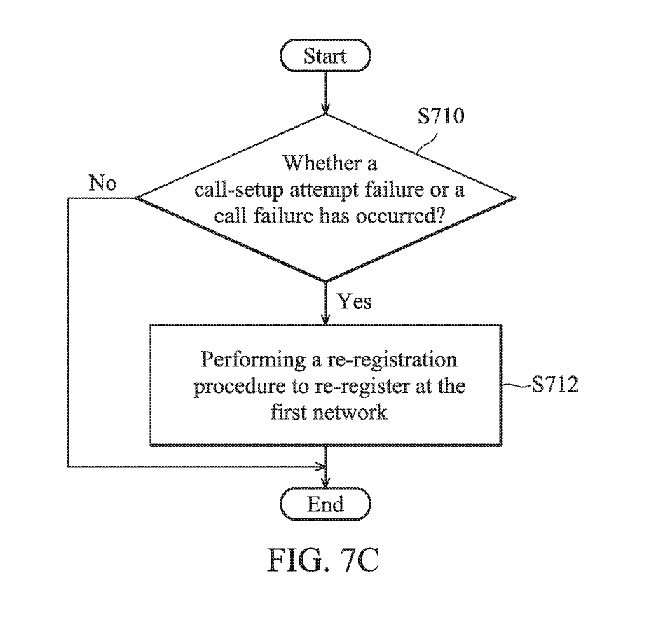

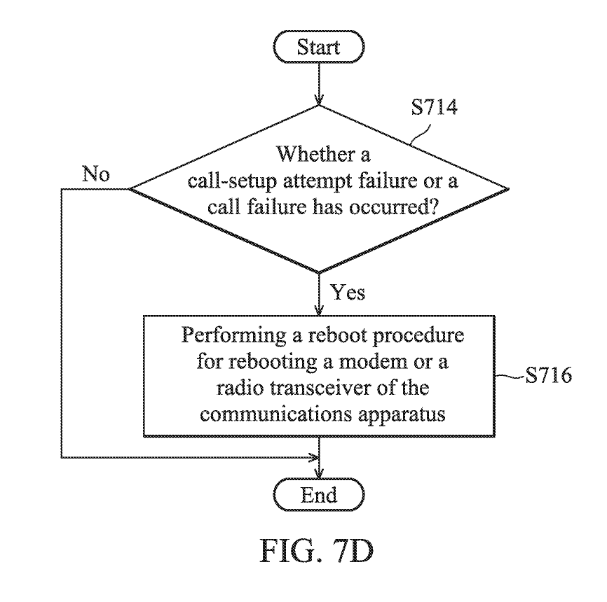

FIG. 7A is a flow chart of a method for increasing the possibility of a successful call-setup of a communications apparatus according to a first embodiment of the invention. According to the first embodiment of the invention, if the processor determines that a call-setup attempt failure or a call failure has occurred (Step S702), the processor may increase transmission power of the communications apparatus for transmitting wireless radio frequency signals (Step S704). It should be noted that the determination made in step S702 may also be replaced by any of the predetermined call-setup behaviors illustrated above, and the invention should not be limited thereto.

FIG. 7B is a flow chart of a method for increasing the possibility of a successful call-setup of a communications apparatus according to a second embodiment of the invention. Suppose that the communications apparatus is currently registered at a first network. According to the second embodiment of the invention, if the processor determines that a call-setup attempt failure or a call failure has occurred (Step S706), the processor may select a second network which is different from the first network and which is also not in a failed network list and perform a registration procedure to register at the second network (Step S708). It should be noted that the determination made in step S706 may also be replaced by any of the predetermined call-setup behaviors illustrated above, and the invention should not be limited thereto.

FIG. 7C is a flow chart of a method for increasing the possibility of a successful call-setup of a communications apparatus according to a third embodiment of the invention. Suppose that the communications apparatus is currently registered at a first network. According to the third embodiment of the invention, if the processor determines that a call-setup attempt failure or a call failure has occurred (Step S710), the processor may perform a re-registration procedure to re-register at the first network (Step S712). It should be noted that the determination made in step S710 may also be replaced by any of the predetermined call-setup behaviors illustrated above, and the invention should not be limited thereto.

FIG. 7D is a flow chart of a method for increasing the possibility of a successful call-setup of a communications apparatus according to a fourth embodiment of the invention. According to the fourth embodiment of the invention, if the processor determines that a call-setup attempt failure or a call failure has occurred (Step S714), the processor may perform a reboot procedure for rebooting a modem or a radio transceiver of the communications apparatus (Step S716). It should be noted that the determination made in step S710 may also be replaced by any of the predetermined call-setup behaviors illustrated above, and the invention should not be limited thereto.

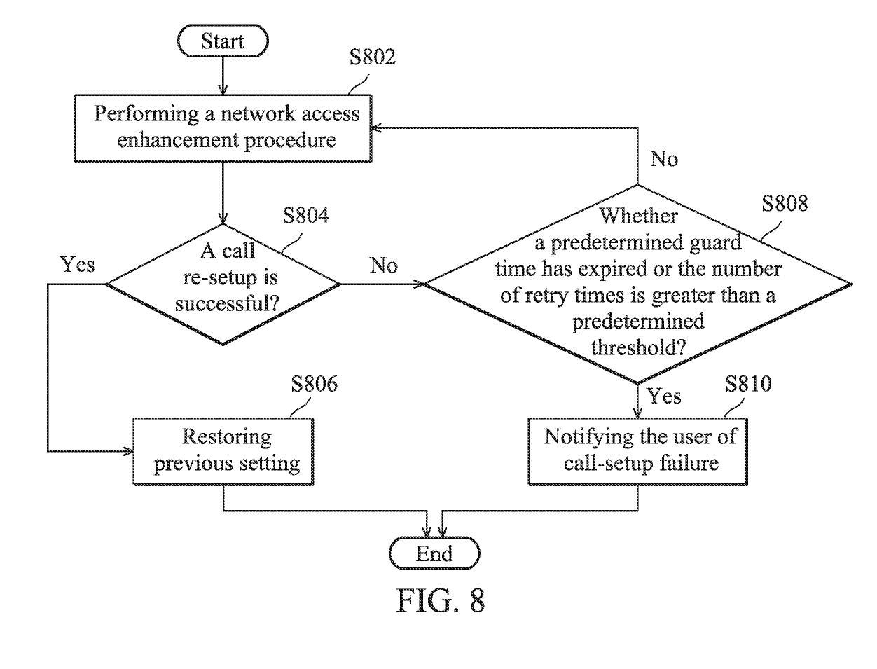

FIG. 8 is a flow chart of a method for increasing the possibility of a successful call-setup of a communications apparatus according to a fifth embodiment of the invention. After performing a network access enhancement procedure illustrated above (Step S802), the processor may determine whether a subsequent call re-setup is successful after applying the network access enhancement (Step S804). If so, the processor may restore the setting before applying the network access enhancement (Step S806). As an example, if the transmission power has been increased in step S802, the processor may resume the original transmission power based on the negotiation result as discussed above. In another example, the processor may also update the failed network list according to the current call re-setup result, or may delete the record regarding the network device having the successful call re-setup result.

If the call re-setup is still not successful, the processor may determine whether a predetermined guard time has expired or whether the number of retry times is greater than a predetermined threshold (Step S808). If not, the processor may again perform the network access enhancement procedure illustrated above (and increase the counting number of retry times by one). If so, the processor may notify the user of call-setup failure (Step S810).

It should be noted that, as discussed above, if the communications apparatus is currently unable to use the service (for example, to set up a call) provided by the network device that the communications apparatus is currently camped on or registered at, the communications apparatus may determine to select another network device to camp on or register at. However, if the communications apparatus still selects the target network based on the stored frequency list or the MRU, successive call failures may occur since the same network device will be selected. Based on the embodiments discussed above, successive call failures may be avoided, and the possibility of a successful call-setup may be increased.

This is especially helpful when the user attempts to make a normal call in a limited service state or an out-of-service state (that is, in a state in which only emergency calls can be made). If the processor detects such call-setup behavior, the processor may select a suitable network as discussed above and perform a camp-on and a registration procedure, so as to register at the network and use the communications service provided by the corresponding network device in the network. In this manner, the normal call may be successfully made. Therefore, more efficient communications services can be provided and user experience can be greatly improved.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus, comprising:
a radio transceiver, capable of transmitting or receiving wireless radio frequency signals to or from an air interface; and
a processor, determining whether one of a plurality of predetermined call-setup behaviors has occurred and if one of the plurality of predetermined call-setup behaviors has occurred, performing a network access enhancement procedure to increase possibility of a successful call-setup.

2. The communications apparatus as claimed in claim 1, wherein the plurality of predetermined call-setup behaviors comprises one or a combination of: successive call-setup attempt failures, successive call failures, a call-setup attempt made in a poor signal quality area, a reboot procedure that has been triggered, or a flight-mode leaving procedure that has been triggered.

3. The communications apparatus as claimed in claim 1, wherein in the network access enhancement procedure, the processor increases transmission power for transmitting the wireless radio frequency signals.

4. The communications apparatus as claimed in claim 1, further comprising:
a memory device, storing a failed network list recording information regarding network(s) in which call failure or call-setup attempt failure has occurred,
wherein in the network access enhancement procedure, the processor selects a predetermined network which is not in the failed network list to perform a registration procedure.

5. The communications apparatus as claimed in claim 4, wherein the processor updates the failed network list according to one or more call set-up attempt results.

6. The communications apparatus as claimed in claim 4, wherein the processor updates the failed network list according to information received from a network device or a peer communications apparatus.

7. The communications apparatus as claimed in claim 1, wherein in the network access enhancement procedure, the processor performs a re-registration procedure.

8. The communications apparatus as claimed in claim 1, wherein in the network access enhancement procedure, the processor performs a reboot procedure.

9. A method for increasing the possibility of a successful call-setup of a communications apparatus, comprising:
determining whether one of a plurality of predetermined call-setup behaviors has occurred; and
if one of the plurality of predetermined call-setup behaviors has occurred, performing a network access enhancement procedure.

10. The method as claimed in claim 9, wherein the plurality of predetermine call-setup behaviors comprises one or a combination of: successive call-setup attempt failures, successive call failures, a call-setup attempt made in a poor signal quality area, a reboot procedure that has been triggered, or a flight-mode leaving procedure that has been triggered.

11. The method as claimed in claim 9, wherein step of performing a network access enhancement procedure further comprises:
increasing a transmission power of the communications apparatus for transmitting wireless radio frequency signals.

12. The method as claimed in claim 9, wherein step of performing a network access enhancement procedure further comprises:
obtaining information regarding a failed network list recording information regarding network(s) in which call failure or call-setup attempt failure has occurred; and
selecting a predetermined network which is not in the failed network list to perform a registration procedure.

13. The method as claimed in claim 12, further comprising:
updating the failed network list according to one or more call set-up attempt results.

14. The method as claimed in claim 12, further comprising:
receiving the information regarding the failed network list from a network device or a peer communications apparatus.

15. The method as claimed in claim 9, wherein step of performing a network access enhancement procedure further comprises:
performing a re-registration procedure.

16. The method as claimed in claim 9, wherein step of performing a network access enhancement procedure further comprises:
performing a reboot procedure.

17. A method for increasing the possibility of a successful call-setup of a communications apparatus registered at a first network, comprising:
determining whether a call-setup attempt failure or a call failure has occurred; and
if a call-setup attempt failure or a call failure has occurred, increasing transmission power of the communications apparatus for transmitting wireless radio frequency signals, or
selecting a second network which is different from the first network and which is also not in a failed network list and performing a registration procedure to register at the second network, or
performing a re-registration procedure to register at the first network, or
performing a reboot procedure for rebooting a modem or a radio transceiver of the communications apparatus.

18. The method as claimed in claim 17, wherein the failed network list is maintained by the communications apparatus based on one or more previous call set-up attempt result.

19. The method as claimed in claim 17, wherein the failed network list is received from a network device or a peer communications apparatus.

20. The method as claimed in claim 17, further comprising:
updating the failed network list according to one or more call set-up attempt results or information received from a network device or a peer communications apparatus.
